(19) United States
(12) Patent Application Publication
(10) Pub. No.: US 2004/0164964 A1
(43) Pub. Date: Aug. 26, 2004

(54) Keyboard with alphabetical key organization and method of use

(76) Inventor: John K. Sokolowski, Tucson, AZ (US)

Correspondence Address: CLARK & BRODY, 1750 K STREET NW, SUITE 600, WASHINGTON, DC, 20006, US

(21) Appl. No.: 10/775,123

(22) Filed: Feb. 11, 2004

Related U.S. Application Data
(60) Provisional application No. 60/448,115, filed on Feb. 20, 2003.

(51) Int. Cl. G09G 5/00

(52) U.S. Cl. 345/168

(57) ABSTRACT

A keyboard adaptable for any type of a computer or other electronic device uses an alphabetical lettering arrangement that id divided into groups of letters for the right and left hands.

This application claims priority under 35 USC 119(e) based on provisional patent application No. 60/448,115 filed on Feb. 20, 2003.

### FIELD OF THE INVENTION

The present invention is directed to a unique keyboard, and in particular, to a keyboard having an alphabetical lettering arrangement to make typing and key location easier.

### BACKGROUND ART

In the prior art, a number of different keyboard configurations have been developed to replace the conventional QWERTY keyboard, but their acceptance has met with limited success. The layout of the QWERTY keyboard is well known and a description thereof is not needed for understanding of the invention.

One drawback in these so-called improved keyboards is the difficulty in learning a new and unfamiliar system. In fact, the QWERTY keyboard is not easily learned since there is no apparent relationship between the location of the various letter keys. Therefore, a need exists to provide improved keyboard configurations that allow a user to more quickly learn locations of letters on the keyboard.

The present invention responds to this need with a keyboard that uses an alphabetical ordering of letter, wherein groups of letters are strategically placed on the keyboard keys so that a user can readily find a desired key, and to do so without having to learn a new key placement system.

### SUMMARY OF THE INVENTION

It is a first object of the present invention to provide an improved keyboard for typing purposes.

Another object of the invention is a method of using the new keyboard.

Other objects and advantages of the present invention will become apparent as a description thereof proceeds.

In satisfaction of the foregoing objects and advantages, the present invention offers an improved keyboard design. The improvement of the invention involves a keyboard having a number of rows of keys, each key having one or more indicia, wherein first, second and third rows include alphabetically-arranged keys. According to the invention, the second row comprises nine letter keys. Starting from a left side of the row and continuing toward the right, the row has the consecutive letters L, M, N, O, P, A, B, C, and D.

To complement this design, the third row of the keyboard that is positioned below the second row has 7 lettered keys. Starting from the left side and continuing toward the right side, the third row includes the consecutive letters H, I, J, K, E, F, and G. The first row of the keyboard has 10 alphabet keys beginning at a left side of the row when looking at the keyboard. The row begins with the letter Q and ends with the letter Z, the letters arranged in alphabetical order between Q and Z.

The inventive keyboard can be used in any type of a device requiring input using keys, e.g., a typewriter, a computer, a personal digital assistant, or the like. The keyboard can take on any shape, including a split keyboard, ergonomically shaped keyboards, etc.

The invention also entails a method of typing on a keyboard wherein the inventive keyboard is used.

### BRIEF DESCRIPTION OF THE DRAWINGS

Reference is now made to the drawings of the invention wherein:

FIG. 1 shows one embodiment of the inventive keyboard;

FIG. 2 shows the letter and other keys of the keyboard of FIG. 1;

FIG. 3 shows a second embodiment of the invention; and

FIG. 4 shows a keyboard reflecting aspects of the second embodiment in the first embodiment of the invention.

### DESCRIPTION OF THE PREFERRED EMBODIMENTS

The invention involves a true alphabetical keyboard configuration, starting with the right hand index finger keeping, for the most part, the ageless QWERTY keyboard ‘per finger’ responsibilities. While the inventive keyboard can mimic the responsibilities of the QWERTY keyboard, it is also especially useful for the multitude of typists that use the “hunt-and-peck” technique since they cannot touch-type using finger responsibility.

In the QWERTY mode, the keyboard allows the left hand finger starting point to remain the same as the QWERTY starting point, while the right hand starting point can be best described as being one key to the left of the QWERTY right hand starting point. This right hand starting point affects the QWERTY left hand B-key responsibility and the E-key in the inventive keyboard is now controlled by the right hand. The groups of ASDF(g) (QWERTY) for the left hand, now becomes LMNO(p); and (h)JKL (QWERTY) becomes ABCD.

As noted above, QWERTY refers to the current standard computer keyboard layout of letters only and is not intended to include reference to symbols, numbers or anything other than letters.

The finger starting point-refers to the 8 keys (4 for each hand) in which a touch typist uses as a starting point. Specifically (ASDF-left hand) and (JKL;-right hand). The semicolon is a responsibility to the right hand as well. The inventive keyboard differs with respect to the QWERTY keyboard in the position of the letter keys, nothing else. The ONLY letter key remaining in the same position is the Q.

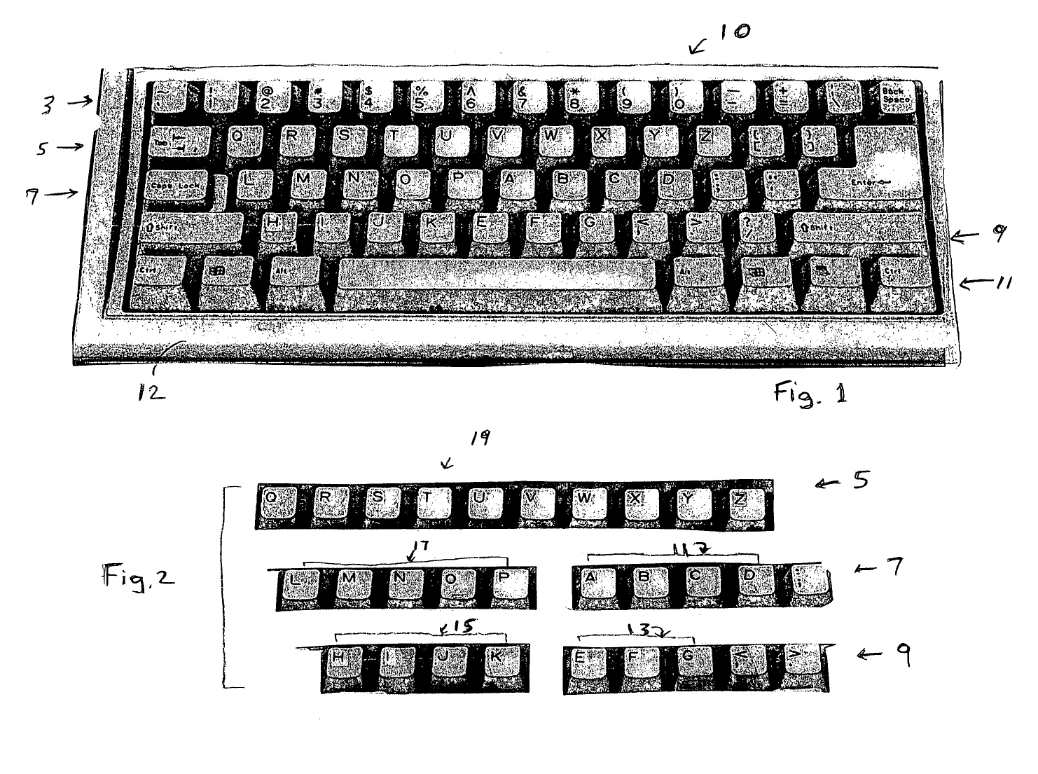

Referring to FIG. 1, a computer keyboard is designated by the numeral 10. The keyboard has five rows 3, 5, 7, 9, 11, and a keyboard frame 1, which includes the electronics and hardware that translates a given key depression into the appropriate signal for processing by a CPU. Row 3 represents the row typically found on a QWERTY keyboard wherein a number of dual function keys are provided, these keys including keys with numbers. As is evident from FIG. 1, the inventive keyboard does not change this row.

Row 5 represents a first row that includes letter keys and other function keys. There are 10 letter keys, and as viewed from the first letter key on the left, the key sequence starts as the letter Q and continues alphabetically until terminating with the letter Z. As with row 3, the inventive keyboard does not contemplate changes to the other non-letter keys.

Row 7 has letter and function keys with nine letter keys. Starting from the left when viewing FIG. 1, the key sequence begins with L, and continues alphabetically for five keys, with the remaining four keys of the five being M, N, O, and P, respectively. Next to the letter P is another group of keys arranged alphabetically, beginning with the letter A, and continuing with letters B, C, and D. In touch typing, the left hand would be used to contact L, M, N, O, and P, with the right hand responsible for A, B, C, D, and the semicolon key that is adjacent to letter key D.

Row 9 has letter and function keys, with seven letter keys. Similar to row 7, and starting from the left, row 9 starts with a group of four keys in alphabetical order, H, I, J, and K. A second group of keys includes E, F, and G, with letter key E adjacent to letter key K.

Row 11 has function keys and remains the same as in the QWERTY keyboard.

FIG. 2 shows the letter keys in isolated groups to better see the alphabetical relationship. Group 11 identifies A, B, C, and D. These are considered the right hand home keys; just as H, J, K, and L are in the QWERTY keyboard. Group 13 identifies E, F, and G. Group 15 identifies H, I, J, and K. Group 17 identifies L, M, N, O, and P; these are the left hand home keys (compare to A, S, D, and F of the QWERTY keyboard). Finally, row identifies group 19, which includes the alphabetical sequence of Q to Z.

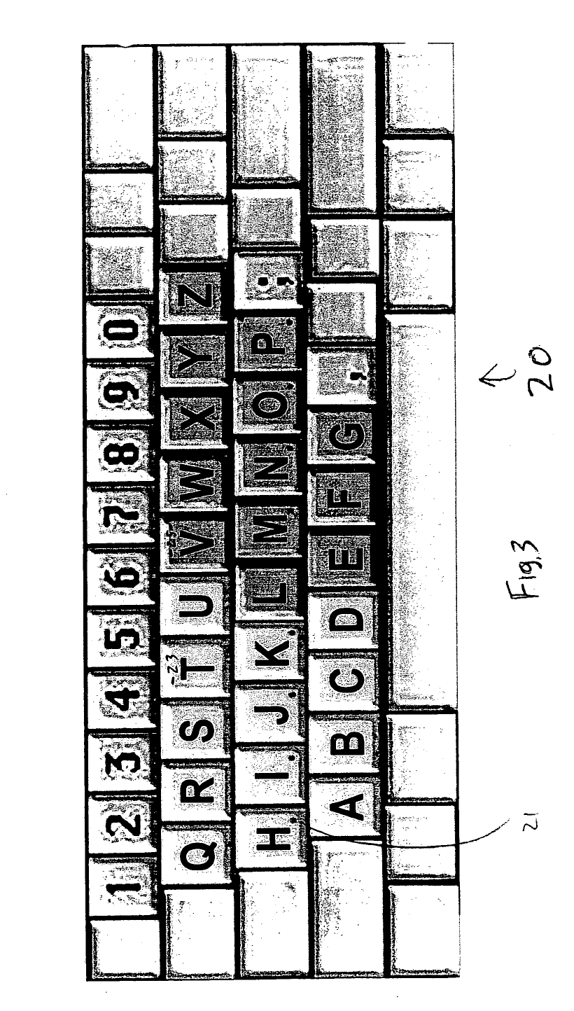

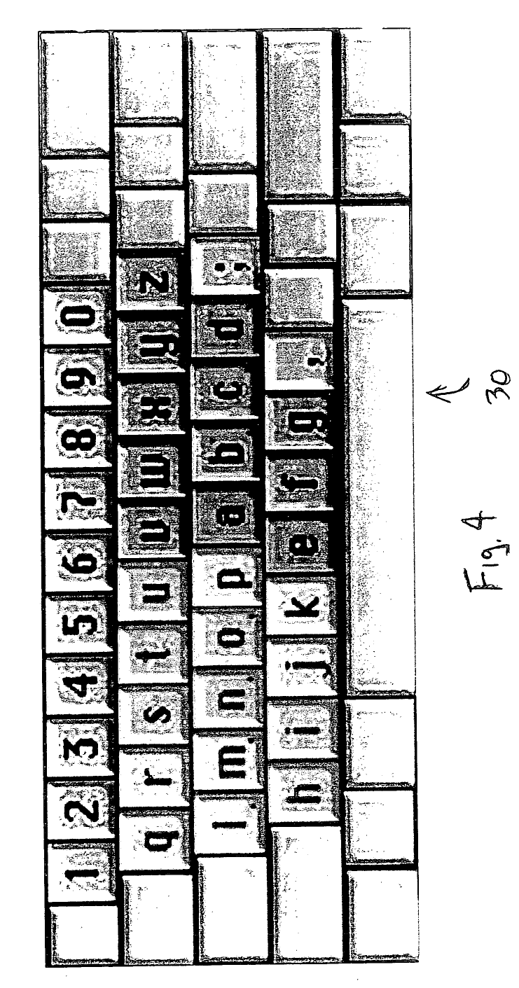

Another embodiment of the invention involves altering rows 7 and 9 as follows. Row 7 would begin with H and continue alphabetically through P. Row 9 would begin with A and continue alphabetically through G. In this embodiment, the left hand home keys would be H, I, J, and K, and the right hand home keys would be M, N, O, and P. This embodiment is illustrated in FIG. 3 as reference numeral 20. FIG. 3 also associates a dot 21, preferably a colored red dot, with each of the home keys, H, I, J, and K, and M, N, O, and P. FIG. 3 also associates one shading 23 with the left hand letters Q-U, H-K, and A-D, and another shading 25 with the right hand letters V-Z, L-P, and E-G. The shading can be any contrasting types so that one can readily distinguish the two groupings of key. Alternatively, different colors can be used for left hand letters and another color for the right hand letters.

FIG. 4 shows a keyboard 30 similar to that shown in FIG. 1, but with the shading shown in FIG. 3 for the left and right hand letters, and dots 21 on the home keys L, M, N, O, and A, B, C, and D.

The invention provides a significant advantage over the current state of the art. In touch typing, a person must have the ability to type without looking at the keyboard, thus requiring the typist to have memorized the layout of the keys.

In the hunt and peck method, one has to visually look for/or at the lettered keys; memorization of the keyboard is not required.

With the inventive keyboard, once a user learns that the keys are grouped in alphabetical order, location of a key is much easier to be found. For example, a user will realize that A, B, C, D, E, F, and V-Z are right hand letters while letter H-K, L-P and Q-U are left hand letters. Further, because of the alphabetical nature of the keyboard, a typist that employs the hunt and peck technique can progress easily to a touch-typing technique without the rigorous training required with a QWERTY keyboard.

Another advantage is that the groups 11-19 of the letters correspond to the cadence of the alphabet recitation. That is, when reciting the alphabet, the sequence is often recited or sung as A-B-C-D (pause), and then E-F-G. Then H-I-J-K are recited, followed by a pause and then the more rapid recitation of L-M-N-O-P. With grouping of letters closely following the alphabet song, it is even easier for a user to learn the placement of the letters on the keyboard for typing.

While this inventive keyboard may not replace the QWERTY keyboard in operations requiring rapid, accurate and voluminous typing, it provides an ideal alternative to users who do not a lot of typing (home users), and/or those that use the hunt and peck method (home and business users).

It should be understood that the keyboard shape shown in FIG. 1 is one example of the invention, but that other keyboard designs can be employed without departing from the invention. For example, certain keyboards are split into two sections with keys for the right hand located on one section, and keys designed for the left hand on another section. The inventive key/lettering arrangement can be adapted for these types of boards such that at least the P and A are separated. In addition, if so desired, the group A-B-C-D, group E, F, G, and group V, W, X, Y, and Z can be associated with one section, and the group H, I, J, K, the group L, M, N, O, P, and group Q, R, S, T, U are associated with the left side of the board.

Furthermore, existing computers could be adapted to use the novel lettering arrangement by altering the computer software such that the keystroke for the letter H outputs the letter A. In this way, a person with a conventional keyboard hooked to a computer could download new software that would change the key strokes. Once the computer is altered, the user could merely rearrange the keys to replicate the arrangement of FIG. 1. The user would then be able to type using the new letter arrangement, and would not have to by a new keyboard. Since modification of the computer software is well within the skill of the art, a detailed description of the manner of adjusting the computer software or adding additional software is not necessary for understanding of the invention.

While the invention is described in terms of all three rows, other keyboard designs could just employ one of the rows. For example, the middle row could include L-P and A-D or H-P, and the other rows could use another arrangement of letters. Similarly, the lower row of H-K and E-G could be used, with the other two rows having another alphabetical arrangement. Two of the three rows could be combined. For example, the middle and lower row could remain the same, and the alphabetical order of the top row could be altered.

While the keyboard is described as a computer keyboard, the letter layout can be used in a keyboard of any type of a device, a PDA, a laptop, a manual or electric typewriter, or virtually any device that employs the QWERTY layout.

As such an invention has been disclosed in terms of preferred embodiments thereof, which fulfills each and every one of the objects of the invention as set forth above, and provides an improved keyboard and method of use.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. In a keyboard having a number of rows of keys, each key having one or more indicia, wherein first, second and third rows include alphabetical keys, the improvement comprising:
the first row having 10 alphabet keys beginning at a left side of the row when looking at the keyboard, the row beginning with the letter Q and ending with the letter Z, the letters arranged in alphabetical order between Q and Z;
the second row positioned below the first row having nine lettered keys and starting from a left side of the row and continuing toward the right including the consecutive letters L, M, N, O, P, A, B, C, and D; and
the third row positioned below the second row having 7 lettered keys, wherein, starting from the left side and continuing toward the right side, the row includes the consecutive letters H, I, J, K, E, F, and G.

2. A computer or other electronic device or a typewriter including a lettered keyboard configuration according to claim 1.

3. The keyboard of claim 1, wherein the keyboard is in two pieces, with one set of letters on one piece and another set on the other piece.

4. In a keyboard having a number of rows of keys, each key having one or more indicia, wherein first, second and third rows include alphabetical keys, the improvement comprising: having the second row comprise nine letter keys, and starting from a left side of the row and continuing toward the right including the consecutive letters L, M, N, O, P, A, B, C, and D.

5. The keyboard of claim 4, wherein the third row positioned below the second row has 7 lettered keys, wherein, starting from the left side and continuing toward the right side, the row includes the consecutive letters H, I, J, K, E, F, and G.

6. The keyboard of claim 4, wherein the first row has 10 alphabet keys beginning at a left side of the row when looking at the keyboard, the row beginning with the letter Q and ending with the letter Z, the letters arranged in alphabetical order between Q and Z.

7. In a method of typing on a keyboard wherein keys are depressed to display letters or other punctuation, graphics or symbols on a display, the improvement comprising providing the keyboard of claim 4 for typing.

8. The method of claim 7, wherein the third row of the keyboard positioned below the second row has 7 lettered keys, wherein, starting from the left side and continuing toward the right side, the row includes the consecutive letters H, I, J, K, E, F, and G.

9. The method of claim 8, wherein the first row of the keyboard has 10 alphabet keys beginning at a left side of the row when looking at the keyboard, the row beginning with the letter Q and ending with the letter Z, the letters arranged in alphabetical order between Q and Z.
